(19) United States
(12) Patent Application Publication
(10) Pub. No.: US 2008/0273908 A1
(43) Pub. Date: Nov. 6, 2008

(54) Sheet discharging device and image forming apparatus

(75) Inventors: Yasuhide Ohkubo, Osaka (JP); Hiroshi Fujiwara, Osaka (JP); Toshikane Nishii, Osaka (JP); Haruyuki Honda, Ibaraki (JP); Masafumi Takahira, Ibaraki (JP); Mizuna Tanaka, Osaka (JP)

Correspondence Address: HARNESS, DICKEY & PIERCE, P.L.C., P.O. BOX 8910, RESTON, VA, 20195, US

(73) Assignee: RICOH COMPANY, LIMITED

(21) Appl. No.: 12/081,276

(22) Filed: Apr. 14, 2008

(30) Foreign Application Priority Data
May 1, 2007 (JP) 2007-121120

(51) Int. Cl. G03G 15/00

(52) U.S. Cl. 399/405

(57) ABSTRACT

A sheet-discharging device includes an upper discharging roller, a lower discharging roller, and a protruding member. The protruding member allows discharging of a sheet to outside from the nip between the upper discharging roller and the lower discharging roller, and prevents taking-in of a sheet that has already been discharged.

### CROSS-REFERENCE TO RELATED APPLICATIONS

The present application claims priority to and incorporates by reference the entire contents of Japanese priority document 2007-121120 filed in Japan on May 1, 2007.

### BACKGROUND OF THE INVENTION

1. Field of the Invention

The present invention relates to a sheet discharging device and an image forming apparatus that includes the sheet discharging device.

2. Description of the Related Art

Some of the image forming apparatuses, such as copiers, printers, facsimile machines, and multifunction products, have a function of reversing a printing sheet (hereinafter, a sheet) in order to print on both sides of the sheet. The act of printing on both sides of a sheet is called duplex printing.

Japanese Patent Application Laid-open No. 2007-76782 discloses a color image forming apparatus that can perform duplex printing.

How the duplex printing is realized on a color image forming apparatus is explained below with reference to FIG. 1. As shown in FIG. 1, a surface of an image carrier is irradiated with a laser beam from an exposing unit based on image data. An electric potential at the parts where the laser beam is irradiated decreases thereby forming an electrostatic latent image on the surface of the image carrier. Then, toner is adhered to the latent image whereby the latent image is developed into a visible image.

Meanwhile, sheets stacked on a feeding cassette are separated through a feeding roller and a separating pad sheet by sheet and are conveyed to a downstream side. A toner image formed on the image carrier is transferred through a transfer roller (a secondary transfer roller) onto the conveyed sheet. The sheet is conveyed to the downstream side and the toner image on the sheet is fixed by a fixing unit that includes a heat source inside. When printing is performed on only one side of the sheet, the sheet is discharged through discharging rollers to a discharging tray.

When performing duplex printing, the discharging rollers are configured to rotate in opposite directions. First, printing is performed on a first side of the sheet as described above. Part of the sheet is discharged once outside through the discharging rollers. The sheet is conveyed back by reversely rotating the discharging rollers and sent to a reversing path. After an image is transferred by the transfer roller onto a second side of the sheet that has passed through the reversing path, the image is fixed by the fixing unit. The sheet on which the image is fixed is discharged to the discharging tray.

Thus, the discharging rollers are used as a reversing unit for reversing a sheet.

The discharging tray is deep enough to accommodate a predetermined number of sheets. However, when sheets that exceed the predetermined number are stacked in the discharging tray, or when sheets are improperly stacked in the discharging tray, the top surface of the stacked sheets may reach an orifice through which sheets are discharged. The top surface of the stacked sheets may reach the orifice if a stacked sheet is curled.

When a sheet P1 is conveyed back under this state, as shown in FIG. 12, a trailing edge of the sheet P1 generally slides on a first side of a sheet P2 on top of sheets stacked on the discharging tray. Therefore, the sheet P2 is pulled to a side of the discharging rollers due to friction caused by sliding or an attractive action caused by static electricity generated between sheets. At this time, when the pulled sheet P2 gets jammed on the way or, when the pulled sheet P2 is conveyed inside the apparatus with the sheet P1 and discharged outside with the sheet P1, an order in which discharged sheets are stacked on the discharging tray sometimes gets wrong.

### SUMMARY OF THE INVENTION

It is an object of the present invention to at least partially solve the problems in the conventional technology.

According to an aspect of the present invention, there is provided a discharging device a first discharging roller rotatable in clockwise and anti-clockwise directions; a second discharging roller group rotatable in clockwise and anti-clockwise, a nip being formed between the first discharging roller and the second discharging roller; and a protruding member that allows discharging of a sheet from the nip to outside, and that prevents taking-in of a sheet that has already been discharged.

According to another aspect of the present invention, there is provided an image forming apparatus comprising a discharging device including a first discharging roller rotatable in clockwise and anti-clockwise directions; a second discharging roller group rotatable in clockwise and anti-clockwise, a nip being formed between the first discharging roller and the second discharging roller; and a protruding member that allows discharging of a sheet from the nip to outside, and that prevents taking-in of a sheet that has already been discharged.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an image forming apparatus according to an embodiment of the present invention;

FIG. 2 is a schematic diagram of a discharging device used shown in FIG. 1;

FIG. 3 is a schematic diagram of one lower discharging roller of the discharging device shown in FIG. 2;

FIG. 4 is a schematic diagram of the other lower discharging roller of the discharging device;

FIG. 5 is a front view of the discharging device viewed in a direction in which a sheet is discharged;

FIG. 6 is a side view of the discharging device shown in FIG. 2;

FIG. 7A is a side view of a relevant part of the discharging device;

FIG. 7B is an enlarged schematic diagram of a protruding member shown in FIG. 7A;

FIG. 8A is a side view of an example of a passing edge;

FIG. 8B is a side view of another example of a passing edge;

FIG. 9A is a side view of an example of an interfering edge;

FIG. 9B is a side view of another example of an interfering edge;

FIG. 10 is a schematic diagram for explaining a modification of the embodiment in which a plurality of protruding members are arranged in the discharging device;

FIG. 11 is a side section view of the discharging device according to the embodiment used in another image forming apparatus; and

FIG. 12 is a schematic diagram of a conventional discharging device.

### DETAILED DESCRIPTION OF THE PREFERRED EMBODIMENTS

Exemplary embodiments of the present invention are explained in detail below with reference to the accompanying drawings.

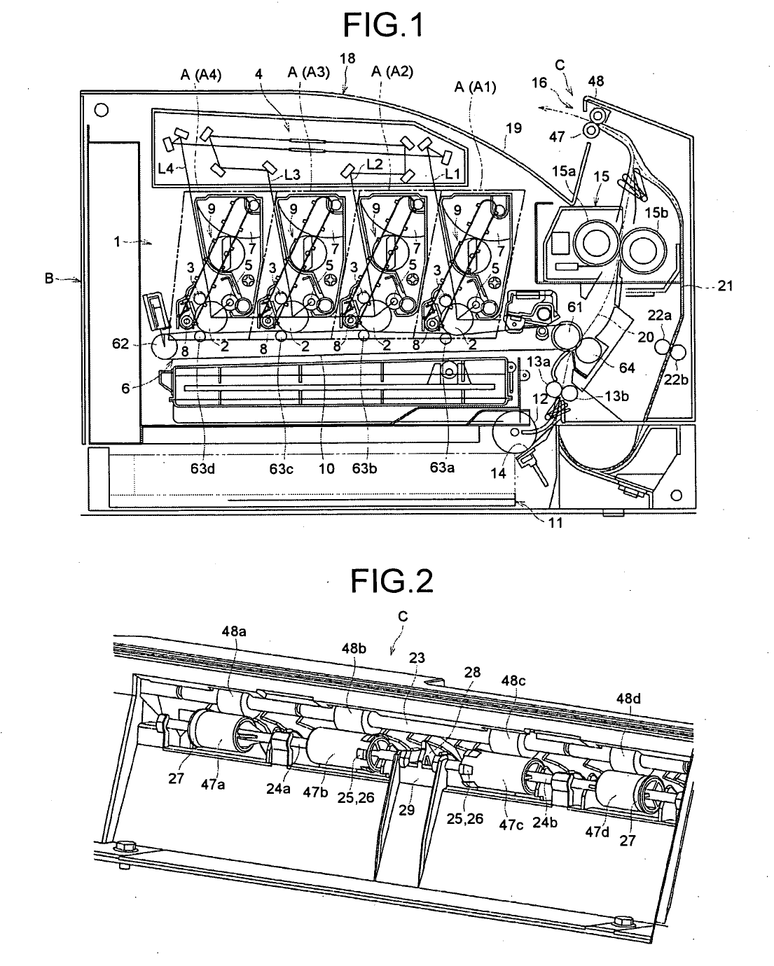

FIG. 1 is a schematic diagram of a color image forming apparatus according to an embodiment of the present invention. The image forming apparatus includes an image forming unit 1 that forms an image by using developers of yellow, cyan, magenta, and black.

The image forming unit 1 includes an image carrier 2 (a photosensitive drum), a charging unit 3 that charges a surface of the image carrier 2, an exposing unit 4 that exposes the surface of the image carrier 2, a developing unit 5 that forms a toner image on the surface of the image carrier 2, and a transferring unit 6 that transfers the toner image onto a sheet.

The image carrier 2, the charging unit 3, and the developing unit 5 among those components constituting the image forming unit 1 are contained in a case as an image forming section. Each of four process units A (a first process unit A1 to a fourth process unit A4) that can be detached from an image forming apparatus body B corresponds to each color of a color image. Moreover, each of the process units A includes a toner container 7 that contains an unused toner and a waste toner, a cleaning blade 8 that removes toner remaining on the surface of the image carrier 2, and a toner conveying unit 9 that conveys the removed waste toner to the toner container 7.

The transferring unit 6 includes four primary transfer rollers 63a, 63b, 63c, and 63d opposed to each of the image carriers 2, an intermediate transfer belt 10 that is stretched over each of the four primary transfer rollers 63a, 63b, 63c, and 63d, a driving roller 61, and a driven roller 62 and that circulates around them, and a secondary transfer roller 64 arranged opposed to the driving roller 61.

A fixing unit 15 includes a heating roller 15a and a pressing roller 15b for fixing a toner image formed at the image forming unit 1 onto a sheet by heat and pressure, and is arranged at a downstream of the secondary transfer roller 64 in a sheet-conveying direction.

The image forming apparatus includes, at a lower portion thereof, a feeding cassette 11 that can contain a plurality of sheets and a feeding roller 12 that sends out the sheets from the feeding cassette 11. A separating pad 14 that separates sheets one by one is also arranged opposed to the feeding roller 12. The separating pad 14 is a rectangular friction pad formed of a material that has a high coefficient of friction and is pressed upward by a pressure spring (not shown) to come into close contact with the feeding roller 12. A pair of registration rollers 13a and 13b that temporarily stops conveying a sheet is positioned between the feeding roller 12 and the secondary transfer roller 64.

A conveying path 20 is arranged to convey a sheet from the feeding cassette 11 through the registration rollers 13a and 13b, the secondary transfer roller 64, and the fixing unit 15 to discharging rollers 47 and 48 arranged at an upper portion of the image forming apparatus body B.

The image forming apparatus includes a duplex printing mechanism. The duplex printing mechanism includes a reversing path 21 for duplex printing that is divided from the conveying path 20 near a discharging orifice 16. A pair of sending rollers 22a and 22b is arranged on the way of the reversing path 21, which is joined to the conveying path 20 at an upstream of the registration rollers 13a and 13b.

A discharging device C that discharges printed sheets outside the apparatus for stacking is arranged at an upper portion of the image forming apparatus. The discharging device C includes the discharging rollers 47 and 48, the discharging orifice 16, and a discharging tray 19. The upper discharging roller 48 can be rotated in both directions based on a driving source (not shown) and the lower discharging roller 47 is driven with rotation of the upper discharging roller 48. Alternatively, the lower discharging roller 47 can be a driving roller and the upper discharging roller 48 can be a driven roller. The discharging tray 19 is formed below the discharging orifice 16 in such a manner that part of an upper cover 18 of the image forming apparatus body is concaved inward.

FIG. 2 is a schematic diagram of the discharging device C viewed from outside. The upper discharging roller 48 includes four upper discharging rollers 48a to 48d that are fixed around a rotating shaft 23. The lower discharging roller 47 includes two lower discharging rollers 47a, 47b are fixed around a rotating shaft 24a, and two lower discharging rollers 47c, 47d that are fixed around a rotating shaft 24b. The rotating shafts 24a, 24b are arranged in the same straight line.

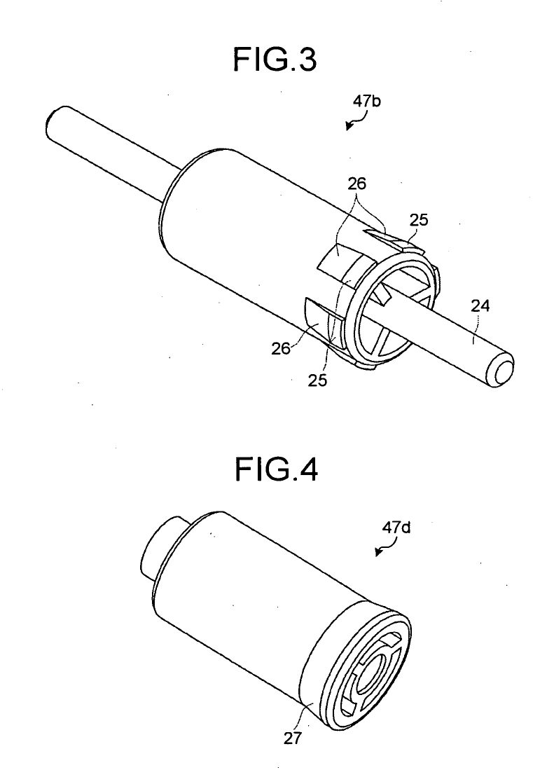

The lower discharging roller 47 include a rigidity-applying unit that applies rigidity to a sheet to be discharged and a pushing unit that discharges the sheet by pushing out a trailing edge thereof. Specifically, a plurality of convex portions 25 is arranged in a circumferential direction on each outer peripheral surface of the lower discharging rollers 47b, 47c, which are arranged near a center in a sheet-width direction, and forms a consecutive concavo-convex shape. An inclined surface 26 that slopes with respect to the rotating shaft 24 is formed (see FIG. 3) on each of the convex portions 25 of an outer diameter surface of the lower discharging rollers 47b, 47c and extends toward an end of the lower discharging rollers 47b, 47c (near the center in the sheet-width direction). Moreover, the two lower discharging rollers 47a, 47d, which are arranged away from the center in the width direction of a direction in which a sheet is conveyed, have an inclined surface 27 expanded toward an end of each of the rotating shafts 24 that is away from the center (see FIG. 4).

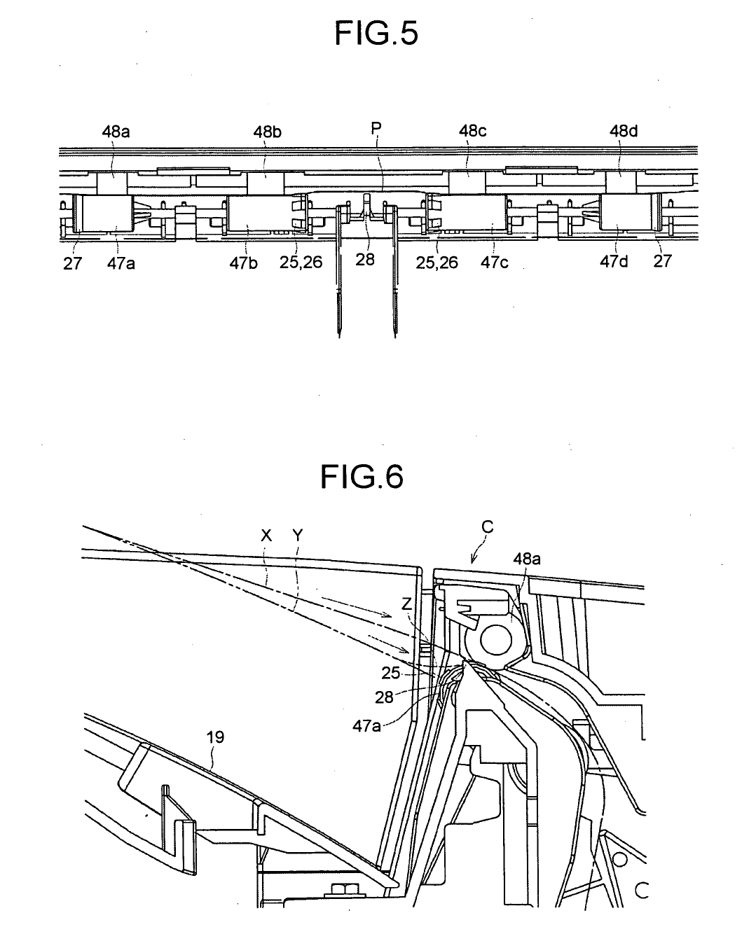

Rigidity is applied to a sheet P to be discharged by the inclined surfaces 26 and 27 of the lower discharging rollers 47a to 47d to bend the sheet P into a wave shape in the sheet-width direction (in an upward-convex shape or in a downward-convex shape) (see FIG. 5). Furthermore, the convex portions 25 of the rotating lower discharging roller 47b, 47d bump into a trailing edge of the sheet P to be discharged and push out the sheet P, so that the sheet P can be urged to discharge.

The upper discharging rollers 48a to 48d do not include the convex portion or the inclined surface on its outer periphery and is brought into contact with the outer peripheral surface of the lower discharging rollers 47a, 47b, 47d, 47d, except the convex portions 25 and the inclined surfaces 27.

A protruding member 28 is arranged in between the lower discharging rollers 47b and 47c. The protruding member 28 is provided as an adjunct integrally with or fixed to a guiding plate 29 made of resin that is arranged near the lower discharging rollers 47b, 47c.

The protruding member 28 is positioned to allow movement of a sheet to be discharged. As shown in FIG. 5, the protruding member 28 is arranged below part of a sheet that is bent to be upward-convex by the convex portions 25 (inclined surfaces 26).

FIG. 6 is a side section view of the discharging device C. A one-dot chain line X indicates a path along which a sheet is discharged through the discharging rollers 47 and 48. A two-dot chain line Y positioned below the one-dot chain line X indicates a position of uppermost one of sheets stacked on the discharging tray 19. A broken line Z that is divided from the two-dot chain line Y indicates a path along which the uppermost sheet on the discharging tray 19 returns to the discharging rollers 47 and 48. The lines X, Y, and Z are indicated as an example and can be changed based on various factors such as a discharging capacity of the discharging device or a sheet material. As shown in FIG. 6, the protruding member 28 is arranged to allow movement of a sheet passing along the discharging path X and to interfere with movement of a sheet passing along the returning path Z.

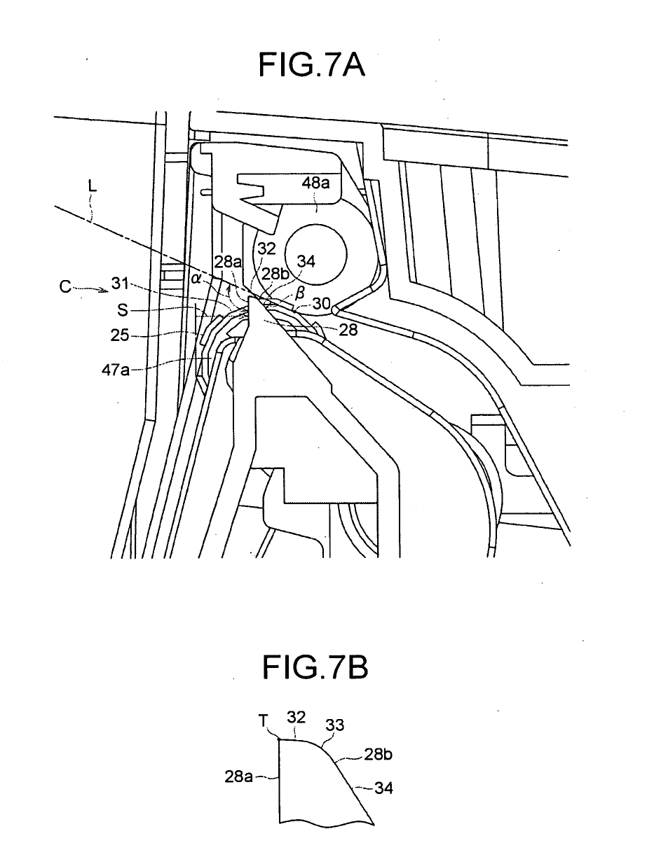

A left side of the protruding member 28 is referred to as a downstream side and a right side thereof is referred to as an upstream side in a sheet-discharging direction shown in FIGS. 7A and 7B. The protruding member 28 that is formed to be triangular viewed from its side includes an interfering edge 28a that is arranged at a downstream and that prevents a sheet that has already been discharged from returning to the discharging rollers 47 and 48, and a passing edge 28b that is arranged at an upstream and that allows movement a sheet to be discharged.

A tip of the protruding member 28 protrudes in an outer-diameter direction of the lower discharging roller 47 beyond an outer periphery of the lower discharging roller 47 and is located at a downstream of a nip 30 between the discharging rollers 47 and 48 in the sheet-discharging direction. In this case, the tip of the protruding member 28 protrudes in the outer-diameter direction beyond the outer-diameter surface of the convex portion 25. In other words, the tip of the protruding member 28 protrudes in the outer-diameter direction at least beyond a bottom surface 31 of a concave portion formed between the convex portions 25.

The tip of the protruding member 28 is located below a path (not shown) along which a trailing edge of a sheet to be discharged passes lest the trailing edge of the sheet run on the tip of the protruding member 28. The tip of the protruding member 28 is arranged upstream in the sheet-discharging direction of a downstream end of the lower discharging roller 47 with respect to a horizontal direction of the lower discharging roller 47 shown by an arrow S in FIG. 7A.

As shown in FIG. 7A, a one-dot chain line is a common tangent L passing through the nip 30 between the discharging rollers 47 and 48. The tip of the protruding member 28 is arranged below the common tangent L. In this case, the interfering edge 28a is formed to be vertical. The interfering edge 28a can be formed in such a manner that an edge of the interfering edge 28a slopes toward a downstream in the sheet-discharging direction.

It is desirable to set an opening angle α formed by the interfering edge 28a and the common tangent L to 45 degrees or larger. Furthermore, it is desirable to set the opening angle α to 90 degrees or larger. When the opening angle α is smaller than 45 degrees, if a sheet that returns to the discharging rollers 47 and 48 comes into contact with the interfering edge 28a, it is impossible to effectively prevent the sheet from returning thereto.

As shown in FIG. 7B, the passing edge 28b includes a first straight portion 32, a convex-shaped curved portion 33, and a second straight portion 34 in the order from a summit T at which the interfering edge 28a and the passing edge 28b intersect to a proximal end. As shown in FIG. 7A, as the second straight portion 34 goes toward the summit T, the second straight portion 34 approaches closer to the common tangent L. Meanwhile, as the first straight portion 32 goes toward the summit T, the first straight portion 32 is positioned away from the common tangent L. It is desirable to set an opening angle β formed by the second straight portion 34 and the common tangent L to 30 degrees or smaller. When the opening angle β exceeds 30 degrees, if a sheet to be discharged should come into contact with the passing edge 28b, the sheet is generally not discharged in a smooth way.

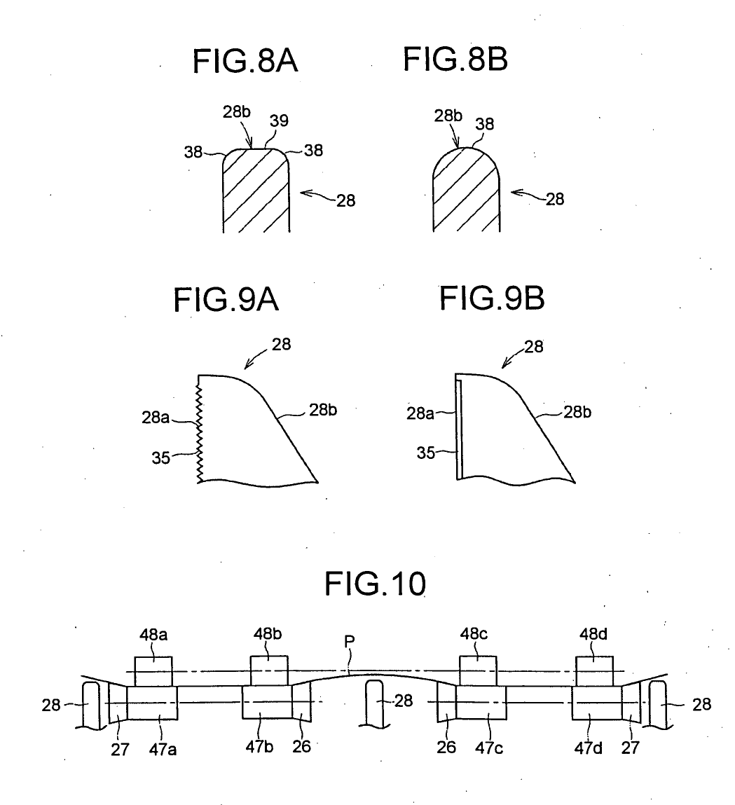

As shown in FIG. 8A, the passing edge 28b includes a convex-shaped curved portion 38 arranged on both sides of the passing edge 28b in a width direction of a cross section. A straight portion 39 is formed to be level in the width direction between the two convex-shaped curved portions 38 and 38. As shown in FIG. 8B, a convex-shaped curved portion 38 can be formed across the passing edge 28b in the width direction.

As shown in FIG. 9A, another example of an interfering edge 28a has a minute concavo-convex shape 35. In addition, as shown in FIG. 9B, a friction member 36 is arranged on still another example of an interfering edge 28a.

The number of protruding member is not limited to one, and a plurality of protruding members can be arranged. As shown in FIG. 10, for example, the protruding member 28 can be arranged at the center in the width direction of a direction in which a sheet is discharged and on both sides of the center. Alternatively, the protruding member 28 is not arranged at the center and can be arranged only on both sides of the center. As shown in FIG. 10, a sheet P held by the discharging rollers 47 and 48 is bent to form an upward-convex shape at the center and on both sides of the center in the sheet-width direction by the inclined surfaces 26 and 27. Each of the protruding members 28 is arranged below each of the bent parts of the sheet P. In addition, it is desirable to arrange the two protruding members 28 and 28 located on both sides in the width direction of a direction in which a sheet is conveyed symmetrically with respect to the protruding member 28 at the center in the width direction of a direction in which a sheet is conveyed. That is because skew of the sheet is prevented if a sheet to be discharged should come into contact with the protruding member 28. Furthermore, it is possible to change the protruding member 28 in height corresponding to a degree at which a sheet is bent.

A basic operation of the image forming apparatus is below explained.

As shown in FIG. 1, when the feeding roller 12 is rotated in response to a feeding signal from a controller (not shown) of the image forming apparatus, only a sheet positioned on top of sheets stacked on the feeding cassette 11 is separated from the rest of the sheets by the feeding roller 12 and the separating pad 14 and is conveyed to the registration rollers 13a and 13b. When a leading edge of the sheet reaches a nip between the registration rollers 13a and 13b, the sheet waits with slack generated thereon to synchronize with a toner image formed in the image-forming unit 1.

As for an image forming operation, first, a surface of the image carrier 2 is charged to a uniform high potential by the charging unit 3. The surface of the image carrier 2 is irradiated with a laser beam (L1 to L4) from the exposing unit 4 based on image data. A potential at the irradiated part decreases and an electrostatic latent image is formed. Toner from the developing unit 5 is adhered to the part of the surface of the image carrier 2 on which the electrostatic latent image is formed to form a toner image with a different color (developing). The toner images with a different color on the image carriers 2 are superimposed on and transferred onto the intermediate transfer belt 10.

The registration rollers 13a and 13b and the feeding roller 12 are driven again and convey a sheet to the secondary transfer roller 64 to synchronize with the toner images superimposed on and transferred onto the intermediate transfer belt 10. The superimposed and transferred toner image is transferred onto the conveyed sheet by the secondary transfer roller 64. The toner image on the sheet is fixed by heat and pressure of the fixing unit 15 and the sheet is conveyed to the discharging rollers 47 and 48.

Rigidity is applied to the sheet on which the toner image is fixed by the inclined surfaces 26 and 27 of the lower discharging roller 47 and, therefore, a concavo-convex shape of the sheet is formed between the discharging rollers 47 and 48, when viewed on a side on which a sheet is discharged (see FIG. 5). The sheet is pushed out from the discharging orifice 16 to the discharging tray 19 by bumping its trailing edge against the convex portions 25 of the rotating lower discharging rollers 47b, 47c. The operations of applying rigidity to and pushing out a sheet lead to stable discharging and aligned stacking on the discharging tray 19 in such a way for a sheet to be almost flat lest even a thin sheet with less rigidity be discharged to the discharging tray 19 with a leading edge of the sheet hanging down.

A sheet to be discharged passes above the protruding member 28 arranged near the discharging rollers 47 and 48. If the sheet should come into contact with the passing edge 28b, the sheet is discharged while smoothly sliding on the passing edge 28b.

When duplex printing is performed, an image is formed on a first side of a sheet in the same manner as in the image-forming operation as described above. The image on the sheet is fixed at the fixing unit 15. Then, part of the sheet is sent outside from the discharging orifice 16 by the discharging rollers 47 and 48. When a trailing edge of the sheet is conveyed to a predetermined position, the discharging rollers 47 and 48 temporarily stop rotating.

When part of the sheet for duplex printing is protruded from the discharging orifice 16 in this manner, a leading edge of the protruded sheet X may come into contact with a first surface of a sheet Y positioned on top of sheets stacked on the discharging tray 19, as shown in FIG. 6, when printed sheets are stacked on the discharging tray 19. When the discharging rollers 47 and 48 are reversely rotated to return the sheet X inside the apparatus again, a trailing edge of the returned sheet X (a leading edge thereof when discharged) slides on the first surface of the printed sheet Y on the discharging tray 19. The printed sheet Y may be pulled back to the discharging rollers 47 and 48 due to friction caused by sliding or an attractive action caused by static electricity generated between sheets.

When the printed sheet Y runs on the lower discharging roller 47 shown by a broken line Z in FIG. 6, an edge of the sheet Y comes into contact with the interfering edge 28a (see FIG. 7A), so that the printed sheet Y is prevented from being pulled back inside the apparatus. Afterwards, even if the edge of the sheet in contact with the protruding member 28 runs on the lower discharging roller 47, when the lower discharging roller 47 next rotates in a direction of discharging sheets (regular rotation), the convex portions 25 bump into the edge of the sheet on the lower discharging roller 47, so that the sheet is pushed out to the discharging tray 19.

On the other hand, when a sheet that has already been discharged is conveyed back with a printed sheet, the printed sheet is separated by the protruding member 28 and the sheet that has already been discharged is conveyed inside the apparatus again furthermore into the reversing path 21 shown in FIG. 1. The sheet conveyed into the reversing path 21 passes through the sending rollers 22a and 22b and reaches the registration rollers 13a and 13b. The sheet is sent out in synchronization with an image formed on the intermediate transfer belt 10 for a second surface of a sheet by rotating the registration rollers 13a and 13b. When the sheet passes along the secondary transfer roller 64, the image is transferred onto the second surface of the sheet. Then, the sheet passes through the fixing unit 15 during which the image on the second surface is fixed, and the sheet is discharged from the discharging orifice 16 to the discharging tray 19 through the discharging rollers 47 and 48. The sheet discharged at this time also passes above the protruding member 28 as described above. If the sheet should come into contact with the passing edge 28b when discharged, the sheet is smoothly discharged without being prevented.

Toner that remains on a surface of each image carrier 2 after an image is transferred is removed by the cleaning blade 8. The removed waste toner is sent to a waste toner collecting unit of the toner container 7 by the toner conveying unit 9 and stored therein.

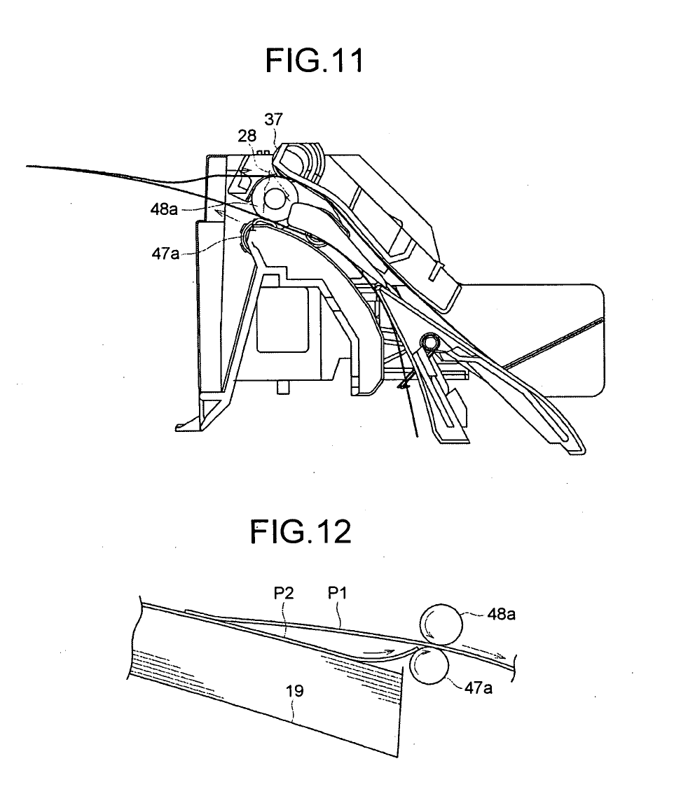

A configuration according to the embodiment of the present invention can be used in an image forming apparatus except the one shown in the above figures. For example, as shown in FIG. 11, an image forming apparatus includes a reversing roller 37 adjacent to the discharging rollers 47 and 48. The protruding member 28 is arranged near the reversing roller 37.

Specifically, as shown in FIG. 11, the lower discharging roller 19a is driven with rotation of the upper discharging roller 48 to discharge sheets to a discharging tray (not shown). The reversing roller 37 is driven with rotation of the upper discharging roller 48 to send part of a sheet outside and return the sheet into the apparatus. The sheet also slides on a first surface of a printed sheet stacked on the discharging tray when the sheet returns, so that the printed sheet sometimes returns to between the reversing roller 37 and the upper discharging roller 48 in the image forming apparatus shown in FIG. 11. Therefore, the protruding member 28 is arranged to prevent the sheet that has already been discharged from returning to a path between the reversing roller 37 and the upper discharging roller 48. Alternatively, the protruding member 28 is arranged to allow movement of a sheet to be discharged from between the discharging rollers 47 and 48 or between the reversing roller 37 and the upper discharging roller 48, so that the protruding member 28 is positioned not to prevent a sheet from being discharged.

The discharging device according to the embodiment is used in the thermal image forming apparatus as described above; however, the discharging device can be used in another image forming apparatus such as an ink-jet image forming apparatus.

According to an embodiment of the present invention, a protruding member does not prevent a sheet from being discharged. However, the protruding member prevents a sheet that has already been discharged from returning to an inside of an image forming apparatus.

Thus, the protruding member prevents the sheet that has already been discharged from returning to a discharging-roller side before the sheet reaches a nip between discharging rollers.

Furthermore, it is possible to avoid a tip of the protruding member touching a sheet to be discharged.

Moreover, it is hard for a trailing edge of a sheet to be discharged to run on the protruding member.

Furthermore, a trailing edge of a sheet to be discharged does not run on the protruding member.

Moreover, it is possible to push out a sheet by bumping a trailing edge of a sheet to be discharged against the convex portions of the rotating lower discharging rollers. Thus, the sheet to be discharged is hard to touch the protruding member. A tip of the protruding member is protruded on a side of an outer diameter of the lower discharging roller at least beyond a bottom surface of a concave portion of the lower discharging roller, so that the protruding member can prevent a sheet that has already been discharged from returning to the discharging-roller side.

Furthermore, it is easy for the protruding member to prevent a sheet that has already been discharged from returning to the discharging-roller side. If a sheet to be discharged should touch the protruding member, it is possible to prevent skew of the sheet.

Moreover, it is possible to reliably prevent the protruding member from interfering with movement of a sheet to be discharged because a space between a second surface of the sheet to be discharged and a tip of the protruding member can be secured. In addition, a rigidity-applying unit enables even a thin sheet that is less rigid to be discharged in an almost flat manner without a leading edge of the sheet hanging down, so that the sheet to be discharged is hard to touch the protruding member.

Furthermore, the protruding member does not prevent a sheet to be discharged that has even a simple shape from being discharged.

Moreover, when a sheet that has already been discharged touches an interfering edge, it is possible to effectively prevent the sheet from returning to a discharging-roller side.

Furthermore, when a sheet that has already been discharged touches the interfering edge, it is possible to reliably prevent the sheet from running on the protruding member.

Moreover, if a sheet to be discharged should touch a passing edge, the passing edge allows the sheet to be smoothly passed.

Furthermore, if a sheet to be discharged should touch a convex-shaped curved portion of the passing edge, the passing edge allows the sheet to be smoothly passed because an area touched by the convex-shaped curved portion and the sheet is small.

Moreover, the protruding member is formed integrally with a guiding plate, which leads to a decrease in manufacturing costs.

Furthermore, the protruding member prevents a sheet that has already been discharged from returning into an image forming apparatus through a nip between a discharging roller and a reversing roller. In addition, the protruding member does not prevent a sheet to be discharged from being discharged. Thus, it is possible to prevent a jam caused by the sheet returned inside the image forming apparatus. In addition, sheets are stably discharged and orderly stacked on a discharging tray. It is possible to prevent a sheet to be discharged from being damaged due to contact with the protruding member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A discharging device comprising:
a first discharging roller rotatable in clockwise and anti-clockwise directions;
a second discharging roller group rotatable in clockwise and anti-clockwise, a nip being formed between the first discharging roller and the second discharging roller; and
a protruding member that allows discharging of a sheet from the nip to outside, and that prevents taking-in of a sheet that has already been discharged.

2. The discharging device according to claim 1, wherein a tip of the protruding member protrudes in a direction of an outer diameter of the second discharging roller beyond an outer periphery of the second discharging roller at a downstream of the nip in a sheet-discharging direction.

3. The discharging device according to claim 1, wherein a tip of the protruding member is arranged below a common tangent passing through the nip.

4. The discharging device according to claim 1, wherein the protruding member is arranged upstream in a sheet-discharging direction of a downstream end portion of the second discharging roller with respect to a horizontal direction of the second discharging roller.

5. The discharging device according to claim 1, wherein a tip of the protruding member is arranged below a path along which a trailing edge of a sheet to be discharged passes.

6. The discharging device according to claim 1, wherein
a concavo-convex portion is arranged on an outer periphery of the second discharging roller, and
a tip of the protruding member is protruded in a direction of an outer diameter of the second discharging roller at least beyond a bottom surface of a concave portion of the concavo-convex portion.

7. The discharging device according to claim 1, wherein the protruding member is arranged at a center in a width direction of a direction in which a sheet is conveyed.

8. The discharging device according to claim 1, wherein the protruding member includes a first protruding member and a second protruding member that are arranged symmetrically with respect to a center in a width direction of a direction in which a sheet is conveyed.

9. The discharging device according to claim 1, wherein
the second discharging roller includes a plurality of third discharging rollers that are arranged along a width direction of a direction in which a sheet is conveyed, and
the protruding member is arranged between adjacent ones of the third discharging rollers.

10. The discharging device according to claim 1, wherein
the second discharging roller includes a rigidity-applying unit by which a sheet to be discharged by the first discharging roller and the second discharging roller is bent to convex upward, downward, or wave-shaped in a sheet-width direction, and
a tip of the protruding member is arranged below a path along which part of the sheet bent to convex upward by the rigidity-applying unit is discharged.

11. The discharging device according to claim 10, wherein
the rigidity-applying unit is arranged on an outer periphery of the second discharging roller and has a surface that is inclined with respect to an axis of the second discharging roller, and
the tip of the protruding member is arranged in a direction of an outer diameter of the second discharging roller beyond an end of a larger diameter of the inclined surface and below the path along which part of the sheet that is bent to convex upward by the rigidity-applying unit is discharged.

12. The discharging device according to claim 1, wherein
a tip of the protruding member is triangular, and
the protruding member includes
an interfering edge that is arranged at a downstream in a sheet-discharging direction to prevent a sheet that has been already discharged from returning to the nip; and
a passing edge that is arranged at an upstream in the sheet-discharging direction and that allows movement of a sheet to be discharged from the nip.

13. The discharging device according to claim 12, wherein an opening angle formed by the interfering edge and a common tangent passing through the nip is set to 90 degrees or larger.

14. The discharging device according to claim 12, wherein the interfering edge is arranged to be vertical or such that a tip of the interfering edge is inclined in a downstream direction in which a sheet is discharged.

15. The discharging device according to claim 12, wherein an opening angle formed by the passing edge and a common tangent is set to 30 degrees or smaller.

16. The discharging device according to claim 12, wherein the passing edge includes a convex-shaped curved portion in the sheet-discharging direction.

17. The discharging device according to claim 12, wherein the passing edge includes a convex-shaped curved portion in a sheet-width direction.

18. The discharging device according to claim 1, wherein the protruding member is provided as an adjunct integrally with a guiding plate arranged near the second discharging roller.

19. The discharging device according to claim 1, further comprising a reversing roller that is adjacent to the first discharging roller, wherein
the protruding member is arranged to allow movement of a sheet to be discharged from the nip or between the discharging roller and a reversing roller, and
the protruding member is arranged to prevent a sheet that has already been discharged from returning to between the discharging roller and the reversing roller.

20. An image forming apparatus comprising a discharging device including
a first discharging roller rotatable in clockwise and anti-clockwise directions;
a second discharging roller group rotatable in clockwise and anti-clockwise, a nip being formed between the first discharging roller and the second discharging roller; and
a protruding member that allows discharging of a sheet from the nip to outside, and that prevents taking-in of a sheet that has already been discharged.
